(19) United States
(12) Patent Application Publication
(10) Pub. No.: US 2016/0054463 A1
(43) Pub. Date: Feb. 25, 2016

(54) CLOSED-LOOP MULTI-DIMENSIONAL INTERPOLATION USING A MODEL-CONSTRAINED MINIMUM WEIGHTED NORM INTERPOLATION

(71) Applicant: CONOCOPHILLIPS COMPANY, Houston, TX (US)

(72) Inventor: Stephen K. CHIU, Katy, TX (US)

(21) Appl. No.: 14/821,086

(22) Filed: Aug. 7, 2015

Related U.S. Application Data
(60) Provisional application No. 62/039,509, filed on Aug. 20, 2014.

(51) Int. Cl. G01V 1/28

(52) U.S. Cl. CPC G01V 1/282

(57) ABSTRACT

Interpolation of seismic data of a subterranean formation includes: obtaining input seismic data; constructing an initial model by interpolation operation along dominant dips in time domain, wherein the initial model includes structural features of the subterranean formation; interpolating seismic data missing from the input seismic data via model-constrained minimum weighted norm interpolation (MWNI) to generate interpolated data; computing difference between the input seismic data and the interpolated data, wherein the difference is residual data; replacing the initial model using difference between the initial model and the interpolated data to generate an updated-initial model; performing model-constrained MWNI method using the residual data and the updated-initial model; adding the interpolated data from residual data to a previously generated interpolated data.

### CROSS-REFERENCE TO RELATED APPLICATIONS

This application is a non-provisional application which claims benefit under 35 USC §119(e) to U.S. Provisional Application Ser. No. 62/039,509 filed Aug. 20, 2014, entitled “CLOSED-LOOP MULTI-DIMENSIONAL INTERPOLATION USING A MODEL CONSTRAINED MINIMUM WEIGHTED NORM INTERPOLATION,” which is incorporated herein in its entirety.

### FIELD OF THE INVENTION

The present invention relates generally to geophysical exploration. More particularly, but not by way of limitation, embodiments of the present invention include tools and methods for accurately producing images of subsurface geology.

### BACKGROUND OF THE INVENTION

Geophysicists desire regular or regularized data from subsurface geological surveys, such as seismic surveys, for use in geophysical applications in order to accurately produce images of subsurface geology. Examples of geophysical applications that require regularized data include amplitude analysis in offset domain, seismic migrations, and visual profiles of subterranean formations merged from various 3D subterranean surveys. Technical issues such as acquisition geometries, equipment failures, field obstacles (e.g., caverns, rivers, buildings, etc.) or economical limitations can result in collection of irregular data with blanks or gaps (i.e. non-collection of regular data).

Regularizing or generating regular data can be a processor-intensive process. Multi-dimensional interpolation is a regularizing method typically employed to reduce processing burdens. There are several available methods that perform multi-dimensional interpolation. Signal-processing-based methods are commonly used to interpolate or regularize non-uniform field data. These methods include anti-leakage Fourier Transform method (Xu, et al., 2005), POSC (Projection Onto Convex Sets) method (Abma and Kabir, 2006), MWNI (Minimum Weighted Norm Interpolation) method (Liu and Sacchi, 2004), prediction filter technique (Naghizadeh and Sacchi, 2007), rank reduction based methods (Trickett et al., 2010), and tensor based interpolation (Kreimer and Sacchi, 2012).

In particular, previous studies (Trad, 2009) showed MWNI is useful for interpolating sparse data, improving amplitude versus offset (AVO) analysis, and reducing migration artifacts. Furthermore, Chopra and Marfurt (2013) showed that 5D interpolation filling in missing data prior to pre-stack migration produced more complete gathers which resulted in a better balanced stack and a reduction of footprint as well as other attribute artifacts.

Although conventional MWNI methods are effective for interpolating unaliased data, the methods are unable to interpolate regular missing data that are spatially aliased (Naghizadeh and Sacchi, 2010). A common strategy in minimizing aliasing artifacts in MWNI is to use a low-frequency solution assumed to be unaliased to constrain a high-frequency solution (Hermann et al., 2000). However, Cary (2011) pointed out that this approach does not provide enough constraints to overcome the aliasing problem at high-frequency solutions. In addition, if data were aliased in one spatial dimension, multi-dimensional interpolation did not eliminate the aliasing issue, but created interpolated data by mixing unaliased and aliased data in multi-dimensional spaces. Naghizadeh and Sacchi (2007) proposed a multistep autoregressive approach in an attempt to address the aliasing problem. However, their technique may not be flexible enough in computing prediction filters when the data had large and highly irregular data gaps.

Recently, Chiu and Anno (2012) proposed an anti-aliasing MWNI method to avoid the failure of the conventional MWNI in dealing with spatially aliased data. This approach constructs an approximate initial model that is regular without data gaps and uses this regular initial model to compute spectral weights that constrain the least-squares solutions in MWNI. The initial model typically contains estimated dominant-structural features in the available data. The MWNI method constrained by this regular initial model is referred as “model-constrained MWNI”. Model-constrained MWNI minimized aliasing artifacts, improved the fidelity of interpolated data, and provided a more accurate and robust multi-dimensional interpolation.

Since MWNI method or model-constrained MWNI is a global-interpolation method, the least-squares operator tends to be influenced mainly by strong-amplitude seismic events and has less weight from weaker events. If both strong-amplitude and weaker seismic events exist in recorded data, the MWNI or model-constrained MWNI method generally produces good interpolated result for strong-amplitude events, but relatively poor result for weaker seismic events. To minimize loss of the weaker events, both methods divide input data into a number of small data subsets and interpolate each small subset separately. If the data subset is small, the interpolation operator becomes a local operator and cannot interpolate large data gaps properly. Even with a small subset, both methods often fail to reconstruct both the strong and much weaker events together.

### BRIEF SUMMARY OF THE DISCLOSURE

The present invention relates generally to geophysical exploration. More particularly, but not by way of limitation, embodiments of the present invention include tools and methods for accurately producing images of subsurface geology.

One example of a method for interpolating seismic data of a subterranean formation includes: a) obtaining input seismic data; b) constructing an initial model by interpolation operation along dominant dips in time domain, wherein the initial model includes structural features of the subterranean formation; c) interpolating seismic data missing from the input seismic data via model-constrained minimum weighted norm interpolation (MWNI) to generate interpolated data; d) computing difference between the input seismic data and the interpolated data, wherein the difference is residual data; e) replacing the initial model using difference between the initial model and the interpolated data to generate an updated-initial model; f) performing model-constrained MWNI method using the residual data and the updated-initial model; g) adding the interpolated data from residual data to a previously generated interpolated data; and h) repeating steps d) to g) until a selected stopping criterion is met.

Another example of a method for interpolating seismic data of a subterranean formation, the method comprising: a) obtaining input seismic data; b) constructing an initial model by interpolation operation along dominant dips in time domain; c) interpolating seismic data missing from the input seismic data via model-constrained minimum weighted norm interpolation (MWNI) to generate interpolated data; d) computing difference between the input seismic data and the interpolated data, wherein the difference is residual data; e) replacing the initial model using difference between the initial model and the interpolated data to generate an updated-initial model; f) performing model-constrained MWNI using the residual data and the updated-initial model; and g) incorporating the interpolated data from residual data to a previously generated interpolated data.

### BRIEF DESCRIPTION OF THE DRAWINGS

A more complete understanding of the present invention and benefits thereof may be acquired by referring to the following description taken in conjunction with the accompanying drawings in which:

FIG. 1 is a foldmap of synthetic 3D data as described in the Examples.

FIG. 2 shows ideal synthetic data of selected 5 receiver lines as described in the Examples.

FIGS. 3A-3B show foldmaps before and after close-loop model-constrained MWNI as described in the Examples.

FIG. 4 shows decimated data of 5 selected receiver line as described in the Examples.

FIG. 5 shows data interpolated by model-constrained MWNI without division of input 3D data as described in the Examples.

FIG. 6 shows data interpolated by model-constrained 3D MWNI after first residual update without division of input 3D data volume as described in the Examples.

FIG. 7 shows data interpolated by model-constrained 3D MWNI after second residual update without division of input 3D data volume as described in the Examples.

FIG. 8 shows differences between original data before decimation and data after 3D interpolation (difference between FIG. 2 and FIG. 7) as described in the Examples.

FIG. 9 shows data interpolated by model-constrained 3D MWNI with division of input 3D data volume as described in the Examples.

FIG. 10 shows data interpolated by model-constrained 3D MWNI after first residual update with division of input 3D data volume as described in the Examples.

FIG. 11 shows data interpolated by model-constrained 3D MWNI after second residual update with division of input 3D data volume as described in the Examples.

FIG. 12 shows differences between original data before decimation and data after 3D interpolation (difference between FIG. 2 and FIG. 11) described in the Examples.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

The present invention provides systems and methods for interpolating missing data that contain strong-amplitude and weaker seismic events. Amplitude ratio between the strong and weak seismic events is typically greater than 3. As alluded to earlier, the model-constrained MWNI can significantly outperform conventional MWNI method in handling spatially aliased data that are often associated with steeply dipping structures. The present invention extends the usefulness of model-constrained MWNI by incorporating an iterative residual-updated procedure to reconstruct missing data for both strong and weaker seismic events.

Previous work by Liu and Sacchi related complete unknown data x to available incomplete data d by a sampling matrix T as shown in the following:

Tx=d, (1)

where T is a sampling operator with entries given by Tᵢⱼ=1 if i, j contains an observation or Tᵢⱼ=0 if i, j contains a missing data.

The complete unknown data x, frequency by frequency, can be reconstructed by minimizing the following cost function J:

J=∥Tx−d∥²+μ²x^{H}F⁻¹Pₖ⁻²F x, (2)

where μ is a weighing factor controlling the tradeoff between the model norm and misfit of observations, H is a conjugate transpose operator, x^{H} is a conjugate transpose of x, F is a multi-dimensional forward Fourier transform, F⁻¹ is a multi-dimensional inverse Fourier transform, and Pₖ⁻² represents spectral weights in wavenumber domains of fully sampled data.

Liu and Sacchi also proposed that minimizing the cost function J is equivalent to solve the following least-squares solution:

$$( \begin{matrix}T \\ μ W\end{matrix} ) x \approx ( \begin{matrix}d \\ 0\end{matrix} ) , \qquad ( 3 )$$

where the matrix W is given by W=Pₖ⁻¹ F.

With a change of variable: z=W x and set μ to zero, equation 3 becomes

T W⁻¹z≈d. (4)

In some embodiments, a conjugate gradient method can be used to solve for equation (4) in finding the unknown x. Since Pₖ⁻² represents spectral weights in wavenumber domains on the fully sampled multi-dimensional unknown seismic data x and the available seismic field data d generally have missing data, spectral weights cannot be computed directly and are typically unknown. The unknown starting spectral weights can be estimated in two steps. The first step constructs a fully regular initial model by interpolating missing data along the dominant dips in the time domain. The second step uses this fully regular initial model to compute Pₖ⁻². At each frequency, the conjugate gradient solver uses the spectral weights computed this initial model as starting weights to find the solution x. The method does not use the solution from a lower frequency to constrain the solution of next higher frequency, but uses spectral weights computed the initial model as starting weights to guide the least-squares solution in minimizing the aliasing artifacts. The spectral weights are updated iteratively at each conjugate gradient iteration.

Because the spectral weights derived from the initial model only serve as starting weights for the conjugate gradient solver, the initial model does not require an accurately computed model. The use of an approximate model greatly simplifies construction of the initial model from available data.

In some embodiments, the present invention uses a fast and simple 2D interpolation to fill in missing data along the dominant dips in the time domain. This approach captures key structural features in the data and produces a higher signal-to-noise model when compared with available data. This initial model can be effectively used as starting weights to improve the least-squares solutions as well as minimize the aliasing artifacts.

To illustrate construction of an initial model, an example of input data is a 3D seismic stacked volume. The interpolation framework for this example consists of inline, crossline, and time. While time is always regular, the interpolation only operates on two spatial dimensions: inline and crossline directions. A first step interpolates the missing data of each inline profile separately using a 2D linear interpolation operator along dominant dips. A second step repeats the same procedure for all crossline profiles individually. Thus, this is a cascaded 2D interpolation to fill in missing data. If the initial model approaches the true model, the spectral constraints derived from this initial model reduce the computation time considerably as well as taking care of the aliasing artifacts in the MWNI solutions. Even if the initial model deviates from the true model to a large extent, it may not help to reduce the computation time, but it is still an effective constrain for minimizing aliasing in MWNI solutions.

Other interpolation methods such as, but not limited to, radon interpolation, tau-p interpolation, or other more accurate multi-dimensional interpolation techniques such as higher-order singular value decomposition (SVD) and projection onto a convex sets algorithm may also be used to construct an approximate initial model. Although the model-constrained MWNI can reconstruct missing data with minimum aliasing artifacts, it has difficulty interpolating both strong and weak seismic events. The present invention addresses this technical issue by employing an iterative approach to reconstruct both strong and weak seismic events.

A procedural flow of this iterative approach can be summarized as follows: 1) Perform a conventional multi-dimensional model-constrained MWNI including construction of an initial model. For several iterations, {2) Compute the differences between the input data and interpolated data (the differences are referred as residual data); 3) Replace the initial model using the difference between the initial model and interpolated data to create an updated-initial model; another option is to replace the initial model by interpolated data; 4) Perform model-constrained MWNI using the residual data and updated-initial model; 5) Add the interpolated result from residual data to previous interpolated result;} 6) Repeated steps 2 to 5 until a stopping criterion is met.

Steps 2 to 5 can be computed either in frequency domain or time domain. In terms of computational efficiency, it is generally preferable that these steps are performed in frequency domain. This iterative updated scheme forms the closed loop of model-constrained MWNI. In general, the number of iteration rarely goes beyond two or three updates. The closed-loop model-constrained MWNI inherits all the nice properties of model-constrained MWNI including its abilities to handle spatially aliased data, interpolate data from 2D to 5D, and has flexibility to divide the input data into a number of smaller data subsets and interpolate each subset separately to reduce the computational memory.

As the number of iteration increases, the signal in the residual data decreases, while the noise in the residual data increases. High-noise levels can make the interpolated data useless and contaminate previous solution. The present invention addresses this technical issue. Since the initial model is derived from linear interpolation along the dominant dips in the time domain, the linear interpolation along the dominant dips is equivalent to model the most coherent events in the available input data with minimum random background noise. Thus, the initial model has higher signal-to-noise ratios when compared with input data. On the other hand, the model-constrained MWNI also ignores random background noise and produces interpolated data with higher signal-to-noise ratios when compared with input data. The updated-initial model derived from the difference between the initial model and interpolated data typically represents signal instead of noise. The present invention uses the updated-initial model to stabilize the least-square solutions during the iterative residual update, when the noise will have much greater impact on the residual data than on the original data. The model constraint is critical for the residual update to ensure that the interpolation gives stable result when the noise becomes more dominant than the signal.

### Example 1

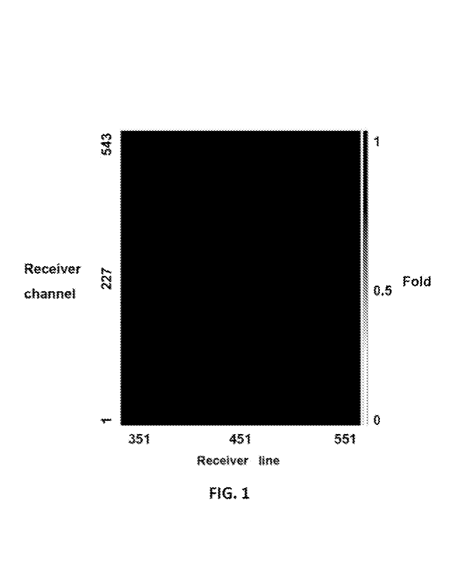

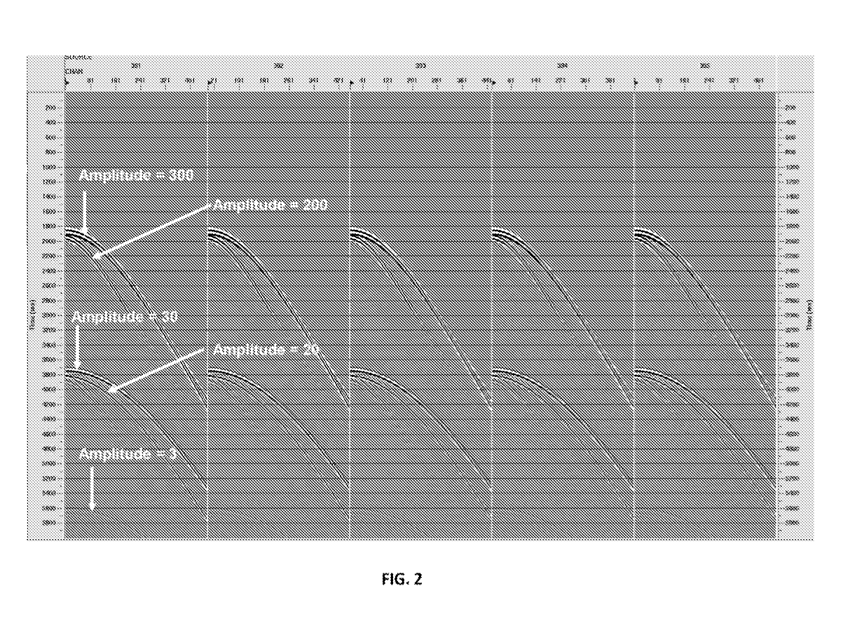

3D synthetic data consists of 201 receiver lines. Each receiver line has 453 receiver stations (FIG. 1). The data contains several diffracted events with amplitude values ranging from 300 to 3 (FIG. 2). The amplitude ratio between the strong and weak event is 100. As diffracted events consist of all dips, decimation of this 3D data volume creates spatially aliased data and offers a vigorous test to validate the robustness of the closed-loop model-constrained MWNI method.

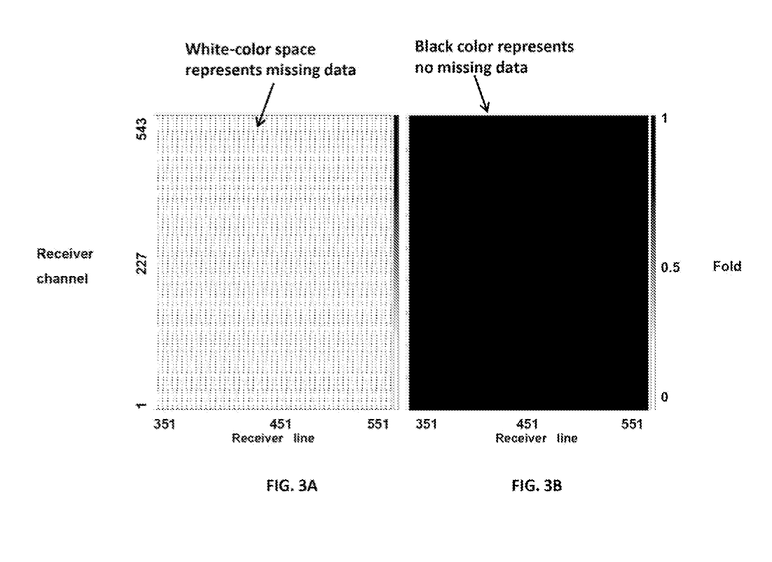

The interpolation framework of this 3D data volume consists of receiver stations within a receiver line, receiver line, and time. To simulate regularly missing data, every second, third, and fourth receiver stations within a receiver line and every second, third, and fourth receiver lines are deleted from the original data (FIG. 3A), creating three data gaps in each spatial direction. The decimation keeps only 6.4 percent of the original data. The interpolation method requires reconstructing 93.6 percent of the missing data from 6.4 percent of the original data.

As a demonstration of the effectiveness, an example of 5 receiver lines are selected in which the decimation deletes every second, third, and fourth receiver stations within a receiver line and removes every second, third, and fourth receiver lines. After the decimation, data become spatially aliased. The objective of the decimation test is to evaluate how well the new interpolation method recreates missing data that consist of diffracted events. In this example, the 3D interpolation uses the decimated 3D data volume to fully reconstruct a 3D volume without missing data (FIG. 3B).

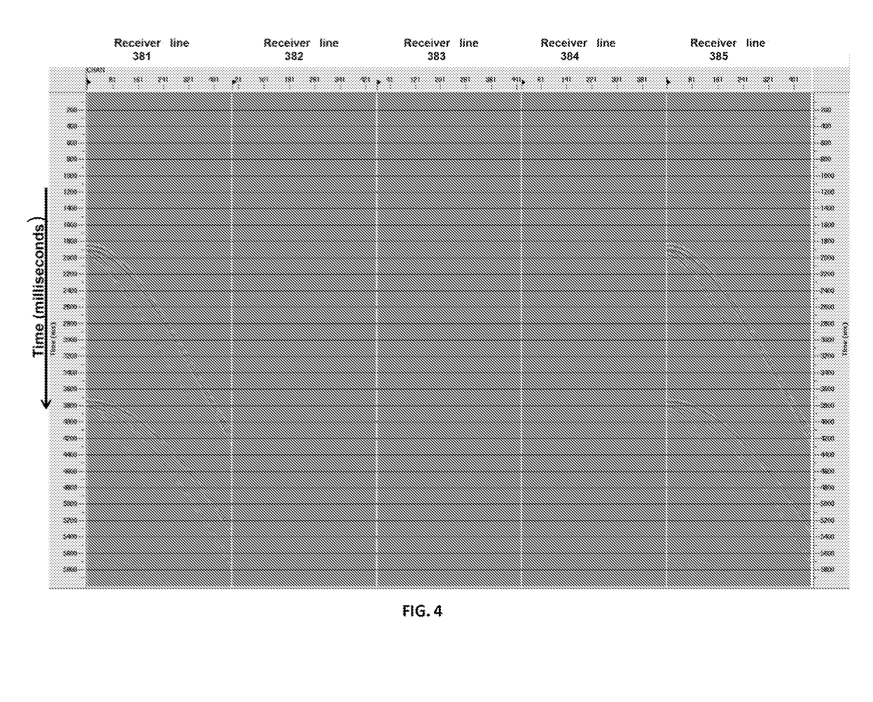

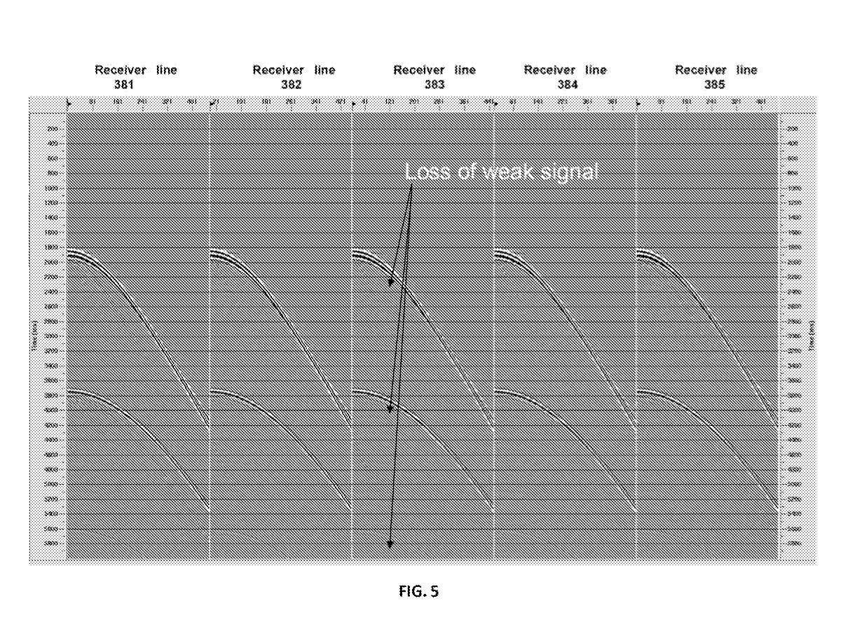

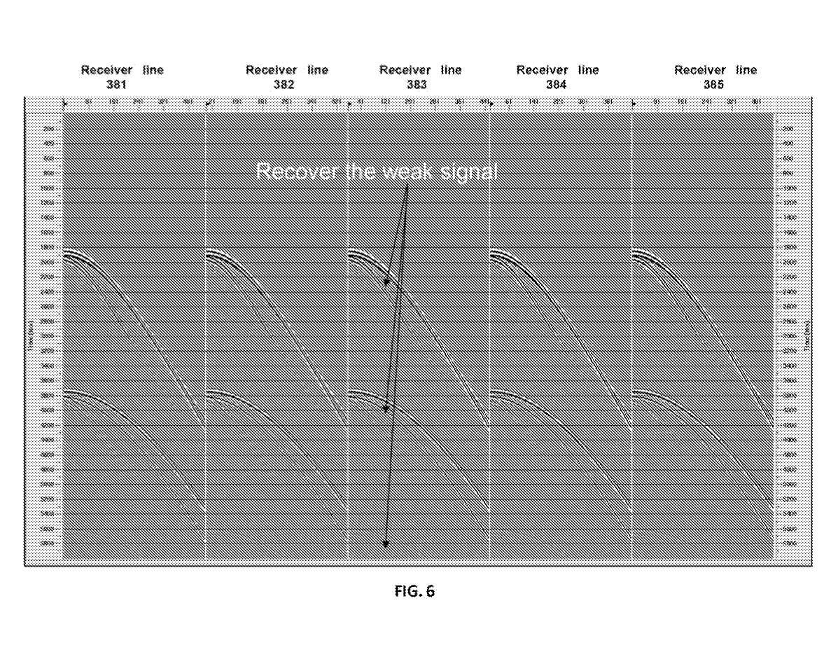

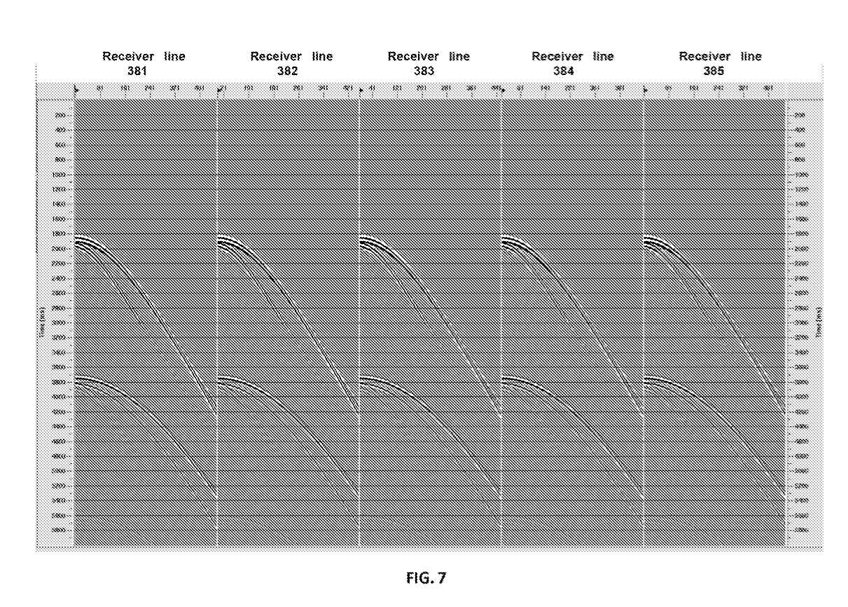

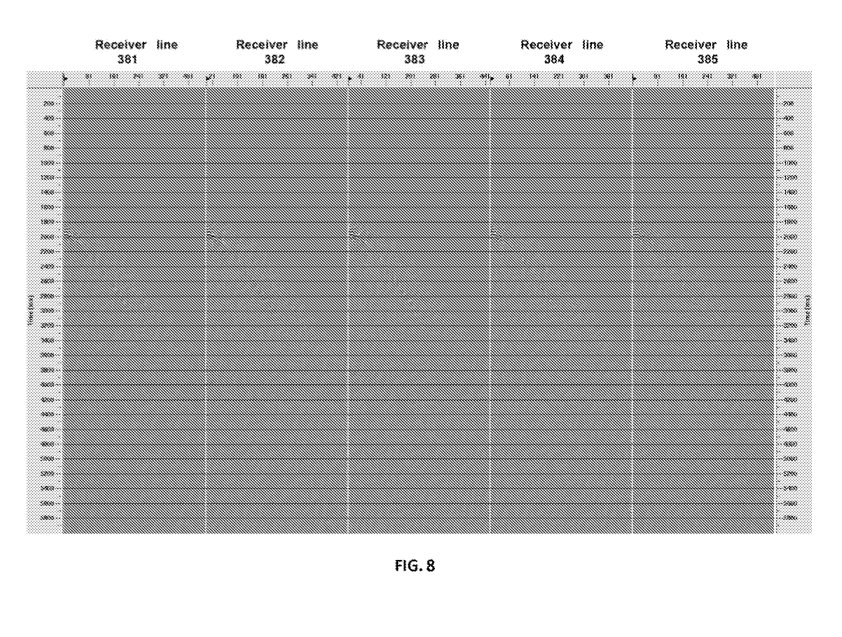

FIG. 4 shows a selected decimated example of 5 receiver lines. Decimation deletes all the data from every second, third, and fourth receiver lines as well as removing every second, third, and fourth receiver stations within a receiver line. The closed-loop model-constrained MWNI does not divide the input 3D data volume into smaller subsets of data. The model-constrained MWNI that corresponds to the iteration zero of the close-loop model-constrained MWNI accurately reconstructs high-amplitude diffracted events, but the weak events are mostly missing as highlight by arrows (FIG. 5). The close-loop model-constrained MWNI starts after the iteration zero and continues to iterate until it meets the stopping criterion. After the first iteration the closed-loop model-constrained MWNI recovers most of the weak events (FIG. 6). The iteration stops after second iteration because it meets the stopping criterion of having a small average residual error which typically ranges between about 10⁻³ to about 10⁻⁵. The model-constrained MWNI after second iteration accurately reconstructs overall data structures (FIG. 7). The small differences between original data before decimation and data after 3D interpolation (FIG. 8) indicates that closed-loop model-constrained MWNI is successful to interpolate missing data that contains both the high-amplitude and weaker diffracted events.

### Example 2

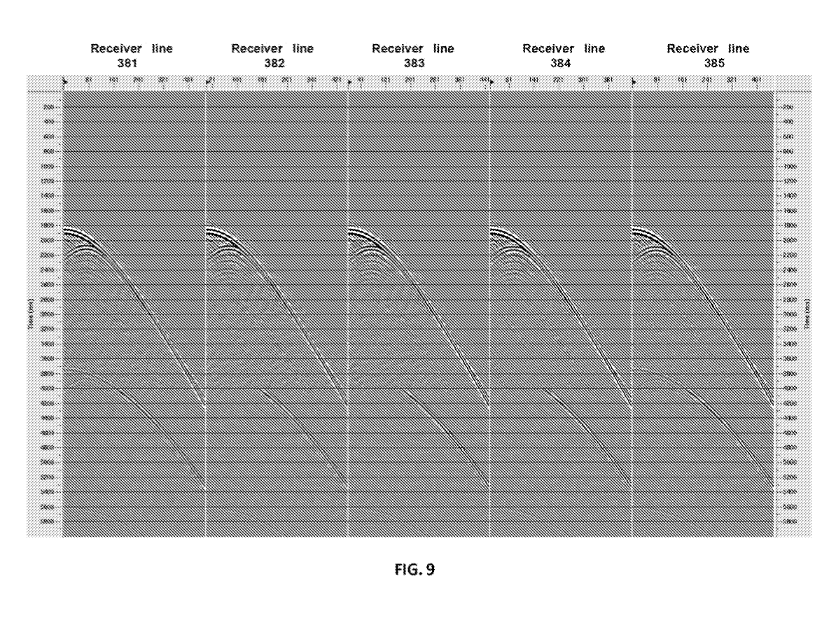

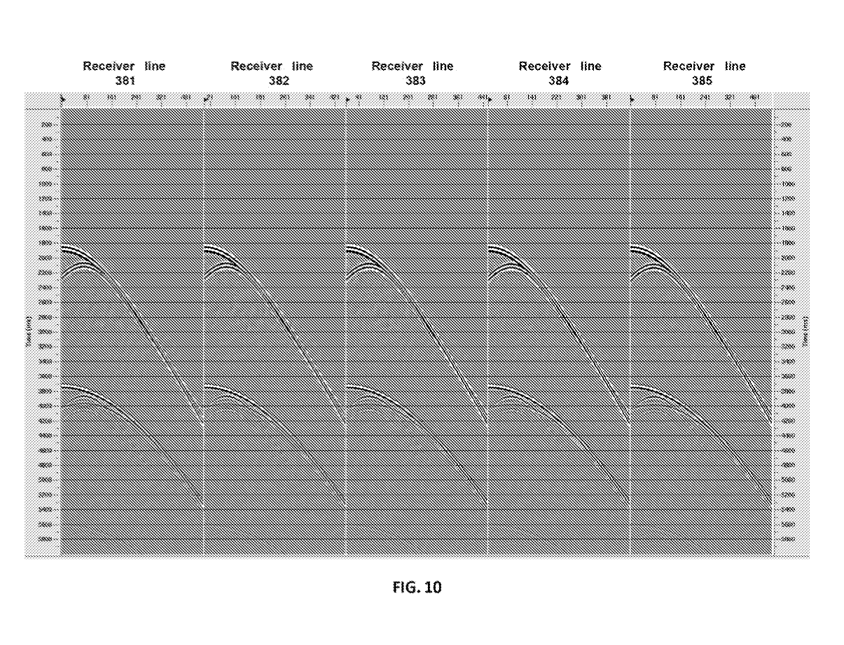

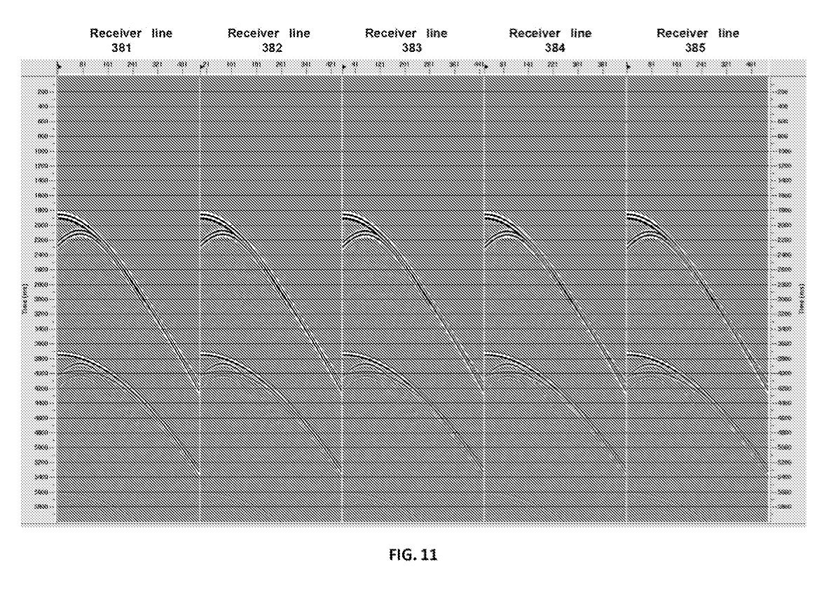

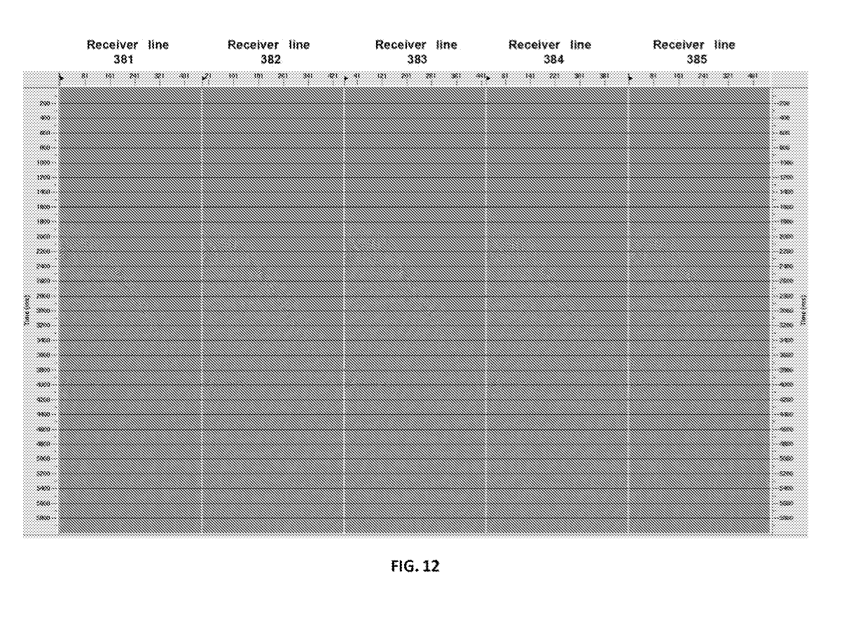

To further demonstrate the effectiveness of the present invention, 6000 msec record length of input 3D data volume is divided into subsets of 500 msec segment of data. The closed-loop model-constrained MWNI interpolates each segment of data separately. The model-constrained MWNI produces a poorer interpolated result (FIG. 9) when compared with FIG. 5. However, the closed-loop model-constrained MWNI recovers both the strong and weak events after 2 iterations (FIGS. 10 and 11) with minor differences between original data before decimation and data after 3D interpolation (FIG. 12). This confirms that the closed-loop model-constrained MWNI is capable to reconstruct the strong and weak events properly in both examples; even only 6.4% of the original data is used to reconstruct 93.6 percent of the missing data.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. Abma, R., and N. Kabir, 2006, 3D interpolation of irregular data with a POCS algorithm, Geophysics, 71, E91-E97.
2. Cary, P., 2011, Aliasing and 5D interpolation with the MWNI algorithm, SEG Expanded Abstracts, 3080-3084.
3. Chiu, S. K., and P. Anno, 2012, Multi-dimensional data reconstruction constrained by a regularly interpolated model, U.S. application No. 61/640,508.
4. Chopra, S., and K. Marfurt, 2013, Preconditioning seismic data with 5D interpolation for computing geometric attributes: The Leading Edge, 32, 1456-1460.
5. Hermann, P., T. Mojesky, M. Magesan, and P. Hugonnet, 2000, Dealiased, high-resolution Radon transforms: 70th Annual International Meeting, SEG, Expanded Abstracts, 1953-1956.
6. Kreimer, N., and M. D. Sacchi, 2012, A tensor higher-order singular value decomposition for prestack noise reduction and interpolation, Geophysics, 77, V113-V122.
7. Liu, B. and M. D. Sacchi, 2004, Minimum Weighted Norm Interpolation of seismic records, Geophysics 69, 1560-1568.
8. Naghizadeh, M., and M. D. Sacchi, 2007, Multistep autoregressive reconstruction of seismic records: Geophysics, 72, no. 6, V111-V118.
9. Naghizadeh, M. and Sacchi, M. D., 2010, On sampling functions and Fourier reconstruction methods: Geophysics, 75, no. 6, WB137-WB151.
10. Trad, D, 2009, Five-dimensional interpolation: Recovering from acquisition constraints: Geophysics, 74, V123-V132.
11. Trickett, S R, L Burroughs, A Milton, L Walton, and R Dack, 2010, Rank-reduction-based trace Interpolation, SEG, Expanded Abstracts 29, 3829-3833.
12. Xu, S., Y. Zhang, and G. Lambare, 2005, Recovering densely and regularly sampled 5D seismic data for current land acquisition: 67th EAGE Conference and Exhibition, Extended Abstracts, W024.

1. A method for interpolating seismic data of a subterranean formation, the method comprising:
a) obtaining input seismic data;
b) constructing an initial model by interpolation operation along dominant dips in time domain, wherein the initial model includes structural features of the subterranean formation;
c) interpolating seismic data missing from the input seismic data via model-constrained minimum weighted norm interpolation (MWNI) to generate interpolated data;
d) computing difference between the input seismic data and the interpolated data, wherein the difference is residual data;
e) replacing the initial model using difference between the initial model and the interpolated data to generate an updated-initial model;
f) performing model-constrained MWNI method using the residual data and the updated-initial model;
g) adding the interpolated data from residual data to a previously generated interpolated data; and
h) repeating steps d) to g) until a selected stopping criterion is met.

2. The method of claim 1, wherein interpolation operation to construct the initial model includes linear interpolation, radon interpolation, tau-p interpolation or multi-dimensional interpolation techniques.

3. The method of claim 1, wherein the updated-initial model is replaced by interpolated data.

4. The method of claim 1, wherein the residual data is computed in frequency or time domain.

5. The method of claim 1, wherein the residual data is computed in overlapped time and spatial domains.

6. The method of claim 1, wherein the updated initial model is computed in frequency or time domain.

7. The method of claim 1, wherein the updated initial model is computed in overlapped time and spatial domains.

8. The method of claim 1, wherein the method interpolates missing data to go from 2D to 5D data.

9. The method of claim 1, wherein the stopping criterion is an average residual error ranging from about 10⁻³ to about 10⁻⁵.

10. A method for interpolating seismic data of a subterranean formation, the method comprising:
a) obtaining input seismic data;
b) constructing an initial model by interpolation operation along dominant dips in time domain;
c) interpolating seismic data missing from the input seismic data via model-constrained minimum weighted norm interpolation (MWNI) to generate interpolated data;
d) computing difference between the input seismic data and the interpolated data, wherein the difference is residual data;
e) replacing the initial model using difference between the initial model and the interpolated data to generate an updated-initial model;
f) performing model-constrained MWNI using the residual data and the updated-initial model; and
g) incorporating the interpolated data from residual data to a previously generated interpolated data.

11. The method of claim 10 further comprising:
h) repeating steps d) to g) until a selected stopping criterion is met.

12. The method of claim 10, wherein interpolation operation to construct the initial model includes linear interpolation, radon interpolation, tau-p interpolation or multi-dimensional interpolation techniques.

13. The method of claim 10, wherein the updated-initial model is replaced by interpolated data.

14. The method of claim 10, wherein the residual data is computed in frequency or time domain.

15. The method of claim 10, wherein the residual data is computed in overlapped time and spatial domains.

16. The method of claim 10, wherein the updated initial model is computed in frequency or time domain.

17. The method of claim 10, wherein the updated initial model is computed in overlapped time and spatial domains.

18. The method of claim 10, wherein the method interpolates missing data to go from 2D to 5D data.

19. The method of claim 10, wherein the stopping criterion is an average residual error ranging from about 10⁻³ to about 10⁻⁵.
